(19) United States
(12) Patent Application Publication
(10) Pub. No.: US 2004/0141070 A1
(43) Pub. Date: Jul. 22, 2004

(54) Digital camera

(76) Inventors: Mamoru Chiku, Sagamihara-shi (JP); Takeshi Matsuo, Yokosuka-shi (JP); Akira Takasugi, Yokohama-shi (JP); Hiroyuki Yamaguchi, Kawasaki-shi (JP); Toyoshige Mikami, Chigasaki-shi (JP); Akiyoshi Jin, Yokohama-shi (JP); Yoko Nakajima, Chigasaki-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/626,765

(22) Filed: Jul. 25, 2003

(30) Foreign Application Priority Data
Jul. 31, 2002 (JP) 2002-223672

(51) Int. Cl. H04N 5/262

(52) U.S. Cl. 348/231.99

(57) ABSTRACT

A digital camera has a detachable recording medium of either a first type into and from which data can be written and erased a plurality of times or a second type into which data can be written only once. A recording switch arrangement has a first-stage switch and a second-stage switch. In cases where the recording medium is of the first type, still-picture data are written into the recording medium when the first-stage switch is actuated. In cases where the recording medium is of the second type, data representative of a still picture are captured and the still picture represented by the captured data is indicated as a preview picture when the first-stage switch is actuated. Then, the captured data are written into the recording medium provided that the second-stage switch is actuated while the first-stage switch remains actuated.

### BACKGROUND OF THE INVENTION

1. Field of the Invention

This invention relates to a digital camera including a device for recording a digital signal representative of a still picture.

2. Description of the Related Art

A known digital camera has a body with which a recording medium is detachably connected. The camera body has a slot for the reception of the recording medium. A digital signal representative of a still picture taken by the camera can be recorded on the recording medium. In general, such a recording medium uses a flash memory into and from which data can be written and erased many times. The flash memory is relatively expensive.

A write-once memory is relatively inexpensive. Data can be written into this memory only once. It is conceivable to use a write-once memory instead of a flash memory as a recording medium for a digital camera. In this conceivable case (not prior art against this invention), the write-once memory is designed to be insertable into a slot in the body of the camera which is originally for receiving a flash memory. Thus, in the conceivable case, either a write-once memory or a flash memory is removably inserted into the slot in the camera body, being detachably connected with the camera body. A user is likely to misunderstand which of a write-once memory and a flash memory is currently connected with the camera body. After data are erroneously written into an area of the write-once memory, it is hard or tough to erase the data from the memory area and to rewrite the data therein.

### SUMMARY OF THE INVENTION

It is an object of this invention to provide an improved digital camera which uses either a first memory into and from which data can be written and erased many times or a second memory into which data can be written only once.

A first aspect of this invention provides a digital camera with which a recording medium is connectable. The digital camera comprises first means for deciding whether a connected recording medium is of a first type into and from which data can be written and erased a plurality of times or a second type into which data can be written only once; a recording switch arrangement having a first-stage switch and a second-stage switch; second means for writing still-picture data into the connected recording medium when the first-stage switch is actuated in cases where the first means decides that the connected recording medium is of the first type; third means for capturing data representative of a still picture and indicating the still picture represented by the captured data as a preview picture when the first-stage switch is actuated in cases where the first means decides that the connected recording medium is of the second type; and fourth means for writing the captured data into the connected recording medium when the second-stage switch is actuated in cases where the first-stage switch remains actuated and the first means decides that the connected recording medium is of the second type.

A second aspect of this invention is based on the first aspect thereof, and provides a digital camera further comprising fifth means for detecting an amount of charges remaining in a battery; sixth means for deciding whether or not the amount detected by the fifth means is greater than a threshold value; seventh means for inhibiting the second means and the third means from responding to actuation of the first-stage switch and for giving a warning to a user in cases where the sixth means decides that the detected amount is not greater than the threshold value; eighth means for setting the threshold value to a first value when the first means decides that the connected recording medium is of the first type; and ninth means for setting the threshold value to a second value greater than the first value when the first means decides that the connected recording medium is of the second type.

A third aspect of this invention is based on the first aspect thereof, and provides a digital camera further comprising an imager for sequentially taking pictures, and fifth means for automatically controlling a focus and an exposure with respect to the pictures taken by the imager independent of an operating condition of the recording switch arrangement.

A fourth aspect of this invention is based on the first aspect thereof, and provides a digital camera further comprising fifth means for indicating, to a user, functions disabled with respect to a recording medium of the second type and enabled with respect to a recording medium of the first type.

A fifth aspect of this invention provides a digital camera with which a recording medium is connectable. The digital camera comprises first means for deciding whether a connected recording medium is of a first type into and from which data can be written and erased a plurality of times or a second type into which data can be written only once; a button being movable among an undepressed position, a first depressed position, and a second depressed position, and passing through the first depressed position as moving from the undepressed position to the second depressed position; second means for writing first still-picture data into the connected recording medium when the button is moved from the undepressed position to the first depressed position in cases where the first means decides that the connected recording medium is of the first type; third means for indicating a still picture represented by second still-picture data as a preview picture when the button is moved from the undepressed position to the first depressed position in cases where the first means decides that the connected recording medium is of the second type; and fourth means for writing the second still-picture data into the connected recording medium when the button is further moved from the first depressed position to the second depressed position in cases where the first means decides that the connected recording medium is of the second type.

A sixth aspect of this invention is based on the fifth aspect thereof, and provides a digital camera further comprising fifth means for detecting an amount of charges remaining in a battery; sixth means for deciding whether or not the amount detected by the fifth means is greater than a threshold value; seventh means for inhibiting the second means and the fourth means from writing the first still-picture data and the second still-picture data into the connected recording medium and for giving a warning in cases where the sixth means decides that the detected amount is not greater than the threshold value; eighth means for setting the threshold value to a first value when the first means decides that the connected recording medium is of the first type; and ninth means for setting the threshold value to a second value greater than the first value when the first means decides that the connected recording medium is of the second type.

A seventh aspect of this invention is based on the fifth aspect thereof, and provides a digital camera further comprising an imager for sequentially taking pictures, and fifth means for automatically controlling a focus and an exposure with respect to the pictures taken by the imager independent of the position of the button.

An eighth aspect of this invention is based on the fifth aspect thereof, and provides a digital camera further comprising fifth means for indicating functions disabled with respect to a recording medium of the second type and enabled with respect to a recording medium of the first type.

A ninth aspect of this invention provides a digital camera with which a recording medium is connectable. The digital camera comprises a first device deciding whether a connected recording medium is of a first type into and from which data can be written and erased a plurality of times or a second type into which data can be written only once; a recording switch arrangement having a first-stage switch and a second-stage switch; a data writer writing still-picture data into the connected recording medium when the first-stage switch is actuated in cases where the first device decides that the connected recording medium is of the first type; and a second device capturing data representative of a still picture and indicating the still picture represented by the captured data as a preview picture when the first-stage switch is actuated in cases where the first device decides that the connected recording medium is of the second type; the data writer writing the captured data into the connected recording medium when the second-stage switch is actuated in cases where the first-stage switch remains actuated and the first device decides that the connected recording medium is of the second type.

A tenth aspect of this invention provides a digital camera with which a recording medium is connectable. The digital camera comprises a first device deciding whether a connected recording medium is of a first type into and from which data can be written and erased a plurality of times or a second type into which data can be written only once; a button being movable among an undepressed position, a first depressed position, and a second depressed position, and passing through the first depressed position as moving from the undepressed position to the second depressed position; a data writer writing first still-picture data into the connected recording medium when the button is moved from the undepressed position to the first depressed position in cases where the first device decides that the connected recording medium is of the first type; and a second device indicating a still picture represented by second still-picture data as a preview picture when the button is moved from the undepressed position to the first depressed position in cases where the first device decides that the connected recording medium is of the second type; the data writer writing the second still-picture data into the connected recording medium when the button is further moved from the first depressed position to the second depressed position in cases where the first device decides that the connected recording medium is of the second type.

### BRIEF DESCRIPTION OF THE DRAWINGS

FIG. 1 is a block diagram of a digital camera according to an embodiment of this invention.

FIG. 2 is a flowchart of a first segment of a control program for a central processing microcomputer in FIG. 1.

FIG. 3 is an indicated picture having a portion representing that a memory card currently connected with a camera body is of a flash type.

FIG. 4 is an indicated picture having a portion representing that a memory card currently connected with the camera body is of a write-once type.

FIG. 5 is a flowchart of a second segment of the control program for the central processing microcomputer in FIG. 1.

FIG. 6 is an indicated picture having portions representing that only a small amount of charges remains in a battery in FIG. 1.

FIG. 7 is a flowchart of a third segment of the control program for the central processing microcomputer in FIG. 1.

FIG. 8 is a flowchart of a fourth segment of the control program for the central processing microcomputer in FIG. 1.

FIG. 9 is a flowchart of a fifth segment of the control program for the central processing microcomputer in FIG. 1.

FIG. 10 is a sectional view of a recording switch arrangement in which a button is in its undepressed position.

FIG. 11 is a schematic diagram of the recording switch arrangement.

FIG. 12 is a sectional view of the recording switch arrangement in which the button is in its partially depressed position.

FIG. 13 is a sectional view of the recording switch arrangement in which the button is in its fully depressed position.

### DETAILED DESCRIPTION OF THE INVENTION

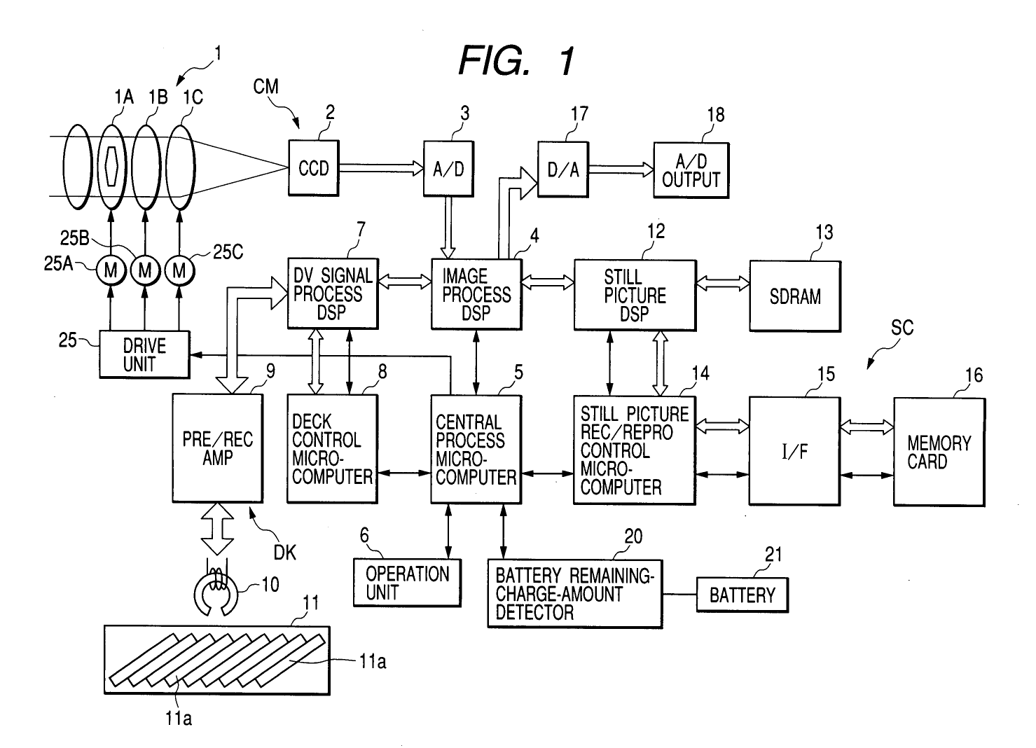

FIG. 1 shows a digital camera or a digital video camera according to an embodiment of this invention. The digital camera of FIG. 1 includes an optical system 1, a CCD imager 2, an A/D converter 3, an image processing DSP (digital signal processor) 4, a central processing microcomputer 5, an operation unit 6, a DV-signal processing DSP 7, a deck control microcomputer 8, a pre/recording amplifier 9, magnetic heads 10, a still-picture DSP 12, an SDRAM (a synchronous dynamic RAM) 13, a still-picture record/reproduction control microcomputer 14, an interface (I/F) 15, a D/A converter 17, an AV output portion 18, and a battery remaining-charge-amount detector 20.

A cassette containing a magnetic tape 11 is removably placed in a body of the digital camera. The magnetic tape 11 can be accessed by the magnetic heads 10. A memory card 16 is detachably connected with the camera body. The memory card 16 is received in a slot in the camera body. The memory card 16 is coupled with the interface 15 when being in a normal position with respect to the camera body. The memory card 16 is of either a first type or a second type. The memory card 16 of the first type includes a flash memory into and from which data can be written and erased many times. The memory card 16 of the second type includes a write-once memory into which data can be written only once. The battery remaining-charge-amount detector 20 is connected with a removable battery 21 for powering the devices 2-10, and 12-20. The battery remaining-charge-amount detector 20 monitors a condition (for example, a voltage) of the battery 21, and detects an amount of charges remaining in the battery 21 by referring to the monitored condition thereof. The battery remaining-charge-amount detector 20 feeds the central processing microcomputer 5 with information about the detected amount of charges remaining in the battery 21.

The image processing DSP 4, the central processing microcomputer 5, the DV-signal processing DSP 7, the deck control microcomputer 8, the still-picture DSP 12, and the still-picture record/reproduction control microcomputer 14 operate in accordance with control programs stored therein, respectively. The control programs are designed to implement steps of operation of the devices 4, 5, 7, 8, 12, and 14 which will be indicated later.

The digital camera can be operated in a mode selected from various modes including a moving-picture recording mode, a moving-picture reproducing mode (a moving-picture playback mode), a still-picture recording mode, and a still-picture reproducing mode (a still-picture playback mode). The mode of operation of the digital camera can be changed by actuating buttons or switches provided in the operation unit 6. The buttons in the operation unit 6 include a moving-picture recording button and a still-picture recording button (a still-picture capturing button) which are separate from each other.

An image of a subject is focused on the CCD imager 2 by the optical system 1. The CCD imager 2 converts the image of the subject into an analog video signal. The CCD imager 2 feeds the analog video signal to the A/D converter 3. The A/D converter 3 changes the analog video signal into a corresponding digital video signal. The A/D converter 3 feeds the digital video signal to the image processing DSP 4. The optical system 1, the CCD imager 2, and the A/D converter 3 compose an intrinsic camera portion CM of the digital camera.

When the operation unit 6 is actuated to request the digital camera to operate in the moving-picture recording mode (for example, when the moving-picture recording button in the operation unit 6 is actuated), a corresponding command signal is transmitted from the operation unit 6 to the central processing microcomputer 5. The central processing microcomputer 5 generates control signals in response to the transmitted command signal. The generated control signals indicate that the moving-picture recording mode of operation of the digital camera is requested. The central processing microcomputer 5 feeds the control signals to the image processing DSP 4 and the deck control microcomputer 8. The control signals cause the devices 4 and 8 to operate in states for implementing the moving-picture recording mode of operation of the digital camera.

During the moving-picture recording mode of operation of the digital camera, the image processing DSP 4 converts the digital video signal, which is fed from the A/D converter 3, into a luminance signal (a Y signal) and chrominance difference signals (R-Y and BY signals) while subjecting the digital video signal or intermediate signals to various types of signal processing such as AGC (automatic gain control), gamma correction, and setup. The image processing DSP 4 outputs the luminance signal and the chrominance difference signals to the DV-signal processing DSP 7. The DV-signal processing DSP 7 is controlled by the deck control microcomputer 8 to implement the following steps of operation. The DV-signal processing DSP 7 subjects the luminance signal and the chrominance difference signals to compression, shuffling, and other processing, and adds control data of various types to the resultant picture signals to get a DV-format signal which conforms with the DV standards. The control data contains tracking information, information about a subcode area, information about an audio recording type, a time code, and date information. The DV-signal processing DSP 7 outputs the DV-format signal to a pre/recording amplifier 9.

During the moving-picture recording mode of operation of the digital camera, the pre/recording amplifier 9 subjects the DV-format signal to NRZI modulation. The pre/recording amplifier 9 feeds the resultant picture signal to the magnetic heads 10. The magnetic heads 10 are mounted on a rotary drum (not shown). It should be noted that only one of the magnetic heads 10 is shown in FIG. 1 for the simplicity of illustration. The magnetic tape 11 is wrapped on the rotary drum. The magnetic heads 10 scan the magnetic tape 11 while recording the picture signal on the magnetic tape 11 along tracks 11a. The DV-signal processing DSP 7, the pre/recording amplifier 9, and the magnetic heads 10 compose a deck portion DK of the digital camera. Preferably, the deck portion DK records an audio signal on the magnetic tape 11 in a way conforming with the DV standards.

When the operation unit 6 is actuated to request the digital camera to operate in the moving-picture playback mode, that is, when the operation unit 6 is actuated to request the digital camera to reproduce a picture signal from the magnetic tape 11, a corresponding command signal is transmitted from the operation unit 6 to the central processing microcomputer 5. The central processing microcomputer 5 generates control signals in response to the transmitted command signal. The generated control signals indicate that the moving-picture playback mode of operation of the digital camera is requested. The central processing microcomputer 5 feeds the control signals to the image processing DSP 4 and the deck control microcomputer 8. The control signals cause the devices 4 and 8 to operate in states for implementing the moving-picture playback mode of operation of the digital camera.

During the moving-picture playback mode of operation of the digital camera, the heads 10 reproduce a picture signal from the magnetic tape 11. The heads 10 output the reproduced picture signal to the pre/recording amplifier 9. The pre/recording amplifier 9 subjects the picture signal to NRZI demodulation to get a reproduced DV-format signal. The pre/recording amplifier 9 feeds the reproduced DV-format signal to the DV-signal processing DSP 7. The DV-signal processing DSP 7 is controlled by the deck control microcomputer 8 to implement the following steps of operation. The DV-signal processing DSP 7 separates the reproduced DV-format signal into picture data and control data. The DV-signal processing DSP 7 subjects the picture data to de-shuffling, expansion, and other processing to get a reproduced luminance signal and reproduced chrominance difference signals. The DV-signal processing DSP 7 outputs the reproduced luminance signal and the reproduced chrominance difference signals to the image processing DSP 4. The DV-signal processing DSP 7 outputs the control data to the deck control microcomputer 8. The image processing DSP 4 converts a set of the reproduced luminance signal and the reproduced chrominance difference signals into a set of component video signals. The image processing DSP 4 outputs the set of component video signals to the D/A converter 17. Alternatively, the image processing DSP 4 may convert a set of the reproduced luminance signal and the reproduced chrominance difference signals into a composite video signal. In this case, the image processing DSP 4 outputs the composite video signal to the D/A converter 17.

During the moving-picture playback mode of operation of the digital camera, the D/A converter 17 changes the set of component video signals or the composite video signal into a corresponding analog video signal. The D/A converter 17 feeds the analog video signal to the AV output portion 18. The AV output portion 18 includes a liquid crystal display which indicates every picture represented by the analog video signal. The liquid crystal display may be replaced by a display of another type. The deck control microcomputer 8 transfers the control data from the DV-signal processing DSP 7 to the central processing microcomputer 5. The central processing microcomputer 5 extracts a time code and date information from the control data. The central processing microcomputer 5 feeds the time code and the date information to the image processing DSP 4 as display information. The image processing DSP 4 superimposes the time code and the date information (the display information) on the set of component video signals or the composite video signal. Accordingly, every picture indicated by the liquid crystal display of the AV output portion 18 has portions corresponding to the time code and the date information. Preferably, the deck portion DK reproduces an audio signal from the magnetic tape 11 in a way conforming with the DV standards. The reproduced audio signal is transmitted to loudspeakers in the AV output portion 18 via the D/A converter 17 and other devices, being converted into corresponding sound.

When the operation unit 6 is actuated to request the digital camera to operate in the still-picture recording mode, a corresponding command signal is transmitted from the operation unit 6 to the central processing microcomputer 5. The central processing microcomputer 5 generates control signals in response to the transmitted command signal. The generated control signals indicate that the still-picture recording mode of operation of the digital camera is requested. The central processing microcomputer 5 feeds the control signals to the image processing DSP 4 and the still-picture record/reproduction control microcomputer 14. The control signals cause the devices 4 and 14 to operate in states for implementing the still-picture recording mode of operation of the digital camera.

During the still-picture recording mode of operation of the digital camera, the image processing DSP 4 converts the digital video signal, which is fed from the A/D converter 3, into a luminance signal (a Y signal) and chrominance difference signals (R-Y and B-Y signals) while subjecting the digital video signal or intermediate signals to various types of signal processing such as AGC (automatic gain control), gamma correction, and setup. The image processing DSP 4 outputs the luminance signal and the chrominance difference signals to the still-picture DSP 12. The still-picture DSP 12 is controlled by the still-picture record/reproduction control microcomputer 14 to implement the following steps of operation. The still-picture DSP 12 captures portions of the luminance signal and the chrominance difference signals as a video signal representing a 1-frame picture which is a still-picture to be recorded. The still-picture DSP 12 stores the captured video signal into the SDRAM 13. Then, the still-picture DSP 12 accesses the video signal in the SDRAM 13, and subjects the video signal to compression and other processing to get R, G, and B signals representative of the still-picture to be recorded. Preferably, the compression is of a type conforming with the JPEG standards. The still-picture DSP 12 feeds the R, G, and B signals to the still-picture record/reproduction control microcomputer 14. Preferably, the still-picture DSP 12 generates control data related to the still picture. The control data contain information about a size of the still picture, and date information concerning the still picture. Preferably, the still-picture DSP 12 adds the control data to the R, G, and B signals before feeding the R, G, and B signals to the still-picture record/reproduction control microcomputer 14. The still-picture record/reproduction control microcomputer 14 generates a file (preferably, a JPEG-based file) of the still picture from the R, G, and B signals. Preferably, the still-picture file additionally contains the control data. The still-picture record/reproduction control microcomputer 14 feeds the still-picture file to the interface 15, and controls the interface 15 to record the still-picture file on the memory card 16. The still-picture DSP 12, the still-picture record/reproduction control microcomputer 14, and the interface 15 compose a still-picture record/reproduction portion SC of the digital camera.

When the operation unit 6 is actuated to request the digital camera to operate in the still-picture reproducing mode, a corresponding command signal is transmitted from the operation unit 6 to the central processing microcomputer 5. The central processing microcomputer 5 generates control signals in response to the transmitted command signal. The generated control signals indicate that the still-picture reproducing mode of operation of the digital camera is requested. The central processing microcomputer 5 feeds the control signals to the image processing DSP 4 and the still-picture record/reproduction control microcomputer 14. The control signals cause the devices 4 and 14 to operate in states for implementing the still-picture reproducing mode of operation of the digital camera.

During the still-picture reproducing mode of operation of the digital camera, the still-picture record/reproduction control microcomputer 14 controls the interface 15 to reproduce a still-picture file from the memory card 16. The still-picture record/reproduction control microcomputer 14 receives the reproduced still-picture file from the interface 15. The still-picture record/reproduction control microcomputer 14 converts the reproduced still-picture file into R, G, and B signals representative of a still picture. The still-picture record/reproduction control microcomputer 14 outputs the R, G, and B signals to the still-picture DSP 12. The still-picture DSP 12 is controlled by the still-picture record/reproduction control microcomputer 14 to implement the following steps of operation. The still-picture DSP 12 stores the R, G, and B signals into the SDRAM 13. Then, the still-picture DSP 12 accesses the R, G, and B signals in the SDRAM 13, and subjects the R, G, and B signals to expansion and other processing to get a reproduced luminance signal and reproduced chrominance difference signals representative of the still-picture. Preferably, the expansion is of a type conforming with the JPEG standards. The still-picture DSP 12 feeds the reproduced luminance signal and the reproduced chrominance difference signals to the image processing DSP 4. The image processing DSP 4 converts a set of the reproduced luminance signal and the reproduced chrominance difference signals into a set of component video signals. The image processing DSP 4 outputs the set of component video signals to the D/A converter 17. Alternatively, the image processing DSP 4 may convert a set of the reproduced luminance signal and the reproduced chrominance difference signals into a composite video signal. In this case, the image processing DSP 4 outputs the composite video signal to the D/A converter 17.

During the still-picture reproducing mode of operation of the digital camera, the D/A converter 17 changes the set of component video signals or the composite video signal into a corresponding analog video signal. The D/A converter 17 feeds the analog video signal to the AV output portion 18. The liquid crystal display in the AV output portion 18 indicates the still picture represented by the analog video signal. The still-picture DSP 12 generates control data related to the still picture. For example, the still-picture DSP 12 extracts control data from the R, G, and B signals given by the still-picture record/reproduction control microcomputer 14. The control data contains information about the size of the still picture and date information concerning the still picture. The still-picture DSP 12 returns the control data to the still-picture record/reproduction control microcomputer 14. The still-picture record/reproduction control microcomputer 14 transfers the control data to the central processing microcomputer 5. The central processing microcomputer 5 extracts the date information from the control data. The central processing microcomputer 5 feeds the date information to the image processing DSP 4 as display information. The image processing DSP 4 superimposes the date information (the display information) on the set of component video signals or the composite video signal. Accordingly, the still picture indicated by the liquid crystal display of the AV output portion 18 has a portion corresponding to the date information.

As shown in FIG. 1, the optical system 1 includes an iris 1A, a zoom lens 1B, and a focus lens 1C which are successively arranged in that order as viewed in the direction of the travel of incident light. The iris 1A can be driven by a motor 25A. The zoom lens 1B can be driven by a motor 25B. The focus lens 1C can be driven by a motor 25C. The motors 25A, 25B, and 25C are activated and deactivated by a drive unit 25 which is controlled by the central processing microcomputer 5.

The image processing DSP 4 generates luminance information for automatic iris control in response to the digital video signal outputted from the A/D converter 3. Also, the image processing DSP 4 generates a contrast information for automatic focus control in response to the digital video signal outputted from the A/D converter 3. The image processing DSP 4 feeds the luminance information and the contrast information to the central processing microcomputer 5. The central processing microcomputer 5 compares the luminance information with a proper luminance. When the luminance information corresponds to higher than the proper luminance, the central processing microcomputer 5 controls the motor 25A via the drive unit 25 to close the iris 1A. On the other hand, when the luminance information corresponds to lower than the proper luminance, the central processing microcomputer 5 controls the motor 25A via the drive unit 25 to open the iris 1A. In this way, the automatic iris control is implemented. The automatic iris control means automatic exposure control. The central processing microcomputer 5 controls the motor 25C via the drive unit 25 in response to the contrast information. Thus, the central processing microcomputer 5 adjusts the position of the focus lens 1C in response to the contrast information. The adjustment of the position of the focus lens 1C is designed to maximize the contrast. In this way, the automatic focus control is implemented.

As previously mentioned, the memory card 16 is of either the first type including a flash memory or the second type including a write-once memory. Preferably, a specified register in the memory card 16 is previously loaded with a type discrimination signal indicating whether the memory card 16 is of the first type or the second type. Data can be written and erased into and from the flash memory many times. Data can be written into the write-once memory only once. In general, the flash memory is relatively expensive. On the other hand, the write-once memory is relatively inexpensive. A user is likely to misunderstand which of the flash type and the write-once type (the first type and the second type) the memory card 16 currently connected with the camera body is of. After data are erroneously written into an area of the memory card 16 of the write-once type, it is hard or tough to erase the data from the memory area and to rewrite the data therein.

The operation unit 6 includes a recording switch arrangement of a two-stage structure. Specifically, the recording switch arrangement has a first-stage switch, a second-stage switch, and a common button mechanically connected with the first-stage switch and the second-stage switch. The first-stage switch and the second-stage switch are operated by the common button as mentioned below. The common button is movable between its uppermost position (its undepressed position) and its lowermost position. Normally, a spring holds the common button in its uppermost position. As the common button is depressed from its uppermost position to its lowermost position, the first-stage switch changes from its OFF state to its ON state and then the second-stage switch changes from its OFF state to its ON state. In other words, as the common button is depressed from its uppermost position to its lowermost position, the first-stage switch is actuated and then the second-stage switch is actuated. As the common button moves from its lowermost position to its uppermost position, the second-stage switch returns to its OFF state and then the first-stage switch returns to its OFF state. In other words, as the common button moves from its lowermost position to its uppermost position, the second-stage switch is de-actuated and then the first-stage switch is de-actuated. The common button is also referred to as the still-picture capturing button or the still-picture recording button. The central processing microcomputer 5 accesses the operation unit 6 and gets information about the states of the first-stage switch and the second-stage switch. In the case where the memory card 16 currently connected with the camera body is of the write-once type, the digital camera operates in response to the states of the first-stage switch and the second-stage switch as follows. When the still-picture capturing button is partially depressed so that only the first-stage switch changes to its ON state, the digital camera captures a current picture and indicates the captured picture as a preview picture. When the still-picture capturing button is further depressed so that the second-stage switch also changes to its ON state, the digital camera records data representative of the captured picture on the memory card 16 as data representative of a still picture. On the other hand, when the still-picture capturing button is released without being further depressed so that the first-stage switch returns to its OFF state and the second-stage switch continues to be in its OFF state, the digital camera prevents data representative of the captured picture from being recorded on the memory card 16. These steps of operation of the digital camera are effective in avoiding still-picture data from being erroneously written into a memory card 16 of the write-once type.

The still-picture record/reproduction control microcomputer 14 operates in accordance with a control program stored therein. The control program has segments for implementing the following steps of operation of the still-picture record/reproduction control microcomputer 14. When a memory card 16 is inserted into the camera body and is connected with the interface 15, information of the connection of the memory card 16 with the interface 15 is transmitted from the interface 15 to the still-picture record/reproduction control microcomputer 14. The still-picture record/reproduction control microcomputer 14 passes the information of the connection of the memory card 16 with the interface 15 to the central processing microcomputer 5. When the memory card 16 is removed from the camera body and is disconnected from the interface 15, information of the disconnection of the memory card 16 from the interface 15 is transmitted from the interface 15 to the still-picture record/reproduction control microcomputer 14. The still-picture record/reproduction control microcomputer 14 passes the information of the disconnection of the memory card 16 from the interface 15 to the central processing microcomputer 5. When receiving a type discrimination command from the central processing microcomputer 5, the still-picture record/reproduction control microcomputer 14 accesses the memory card 16 via the interface 15 and reads out a type discrimination signal from the specified register in the memory card 16. The still-picture record/reproduction control microcomputer 14 decides whether the memory card 16 is of the flash type or the write-once type (that is, the first type or the second type) by referring to the read-out type discrimination signal. The still-picture record/reproduction control microcomputer 14 notifies the central processing microcomputer 5 of the result of the decision.

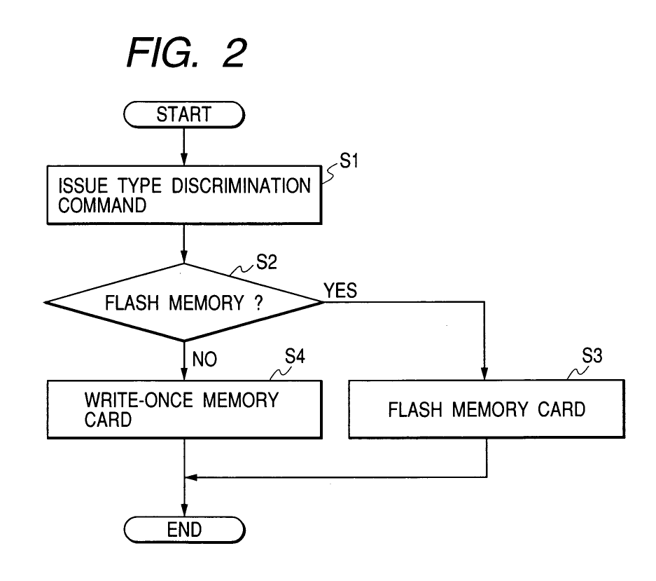

The central processing microcomputer 5 operates in accordance with a control program stored therein. FIG. 2 is a flowchart of a first segment of the control program. The program segment in FIG. 2 is started when a power supply switch in the operation unit 6 is moved to its ON position or when the still-picture record/reproduction control microcomputer 14 informs the central processing microcomputer 5 that a memory card 16 is inserted into the camera body and is connected with the interface 15.

With reference to FIG. 2, a first step S1 of the program segment issues a type discrimination command to the still-picture record/reproduction control microcomputer 14. In response to the type discrimination command, the still-picture record/reproduction control microcomputer 14 accesses the memory card 16 via the interface 15 and reads out a type discrimination signal from the specified register in the memory card 16. The still-picture record/reproduction control microcomputer 14 decides whether the memory card 16 is of the flash type or the write-once type (that is, the first type or the second type) by referring to the read-out type discrimination signal. The still-picture record/reproduction control microcomputer 14 notifies the central processing microcomputer 5 of the result of the decision.

A step S2 following the step S1 receives the decision result from the still-picture record/reproduction control microcomputer 14. The step S2 determines whether the memory card 16 is of the flash type or the write-once type (that is, the first type or the second type) by referring to the decision result. When it is determined that the memory card 16 is of the flash type (the first type), the program advances from the step S2 to a step S3. On the other hand, when it is determined that the memory card 16 is of the write-once type (the second type), the program advances from the step S2 to a step S4.

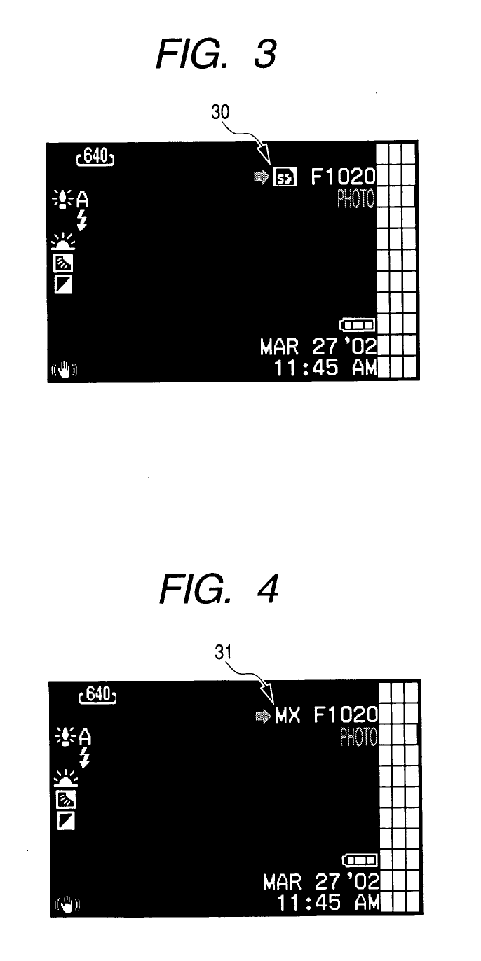

The step S3 sets a type flag to a state indicating that the memory card 16 is of the flash type. Then, the step S3 stores the type flag in a suitable memory within the central processing microcomputer 5. The step S3 controls the liquid crystal display in the AV output portion 18 via the image processing DSP 4 and the D/A converter 17 on an OSD (on screen display) basis to indicate a picture having a portion representing that the memory card 16 currently connected with the camera body is of the flash type. An example of this portion of the indicated picture is denoted by the reference numeral “30” in FIG. 3. After the step S3, the current execution cycle of the program segment ends.

The step S4 sets the type flag to a state indicating that the memory card 16 is of the write-once type. Then, the step S4 stores the type flag in the suitable memory within the central processing microcomputer 5. The step S4 controls the liquid crystal display in the AV output portion 18 via the image processing DSP 4 and the D/A converter 17 on an OSD basis to indicate a picture having a portion representing that the memory card 16 currently connected with the camera body is of the write-once type. An example of this portion of the indicated picture is denoted by the reference numeral “31” in FIG. 4. After the step S4, the current execution cycle of the program segment ends.

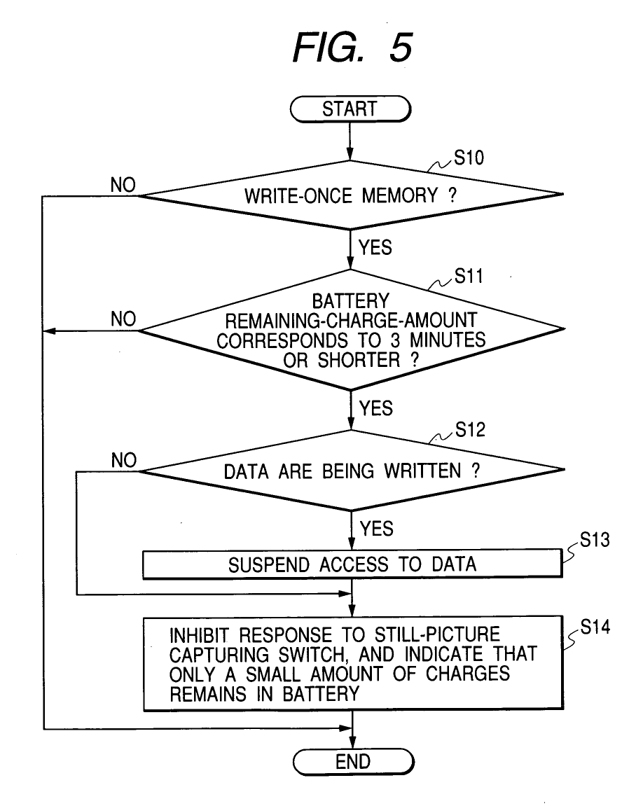

Generally, the power consumption rate during the writing of data into a memory card 16 of the write-once type is greater than that during the writing of data into a memory card 16 of the flash type. If the battery 21 became dead during the writing of data into a memory card 16 of the write-once type, a defective still-picture file would be recorded in an accessed area of the memory card 16. In this case, that area of the memory card 16 would be useless. The digital camera is designed to prevent such a problem. FIG. 5 is a flowchart of a second segment of the control program for the central processing microcomputer 5 which implements the prevention of that problem. The program segment in FIG. 5 is repetitively executed during the still-picture recording mode of operation of the digital camera.

With reference to FIG. 5, a first step S10 of the program segment retrieves the type flag from the suitable memory within the central processing microcomputer 5. The step S10 refers to the type flag and thereby decides whether or not the memory card 16 currently connected with the camera body is of the write-once type. When it is decided that the memory card 16 is of the write-once type, the program advances from the step S10 to a step S11. Otherwise, the program exits from the step S1 and then the current execution cycle of the program segment ends.

The step S11 accesses the battery remaining-charge-amount detector 20 to get information indicating the present amount of charges remaining in the battery 21. The step S11 compares the present amount of remaining charges with a prescribed amount (a threshold value) which enables the digital camera to continuously operate for 3 minutes. When the present amount of remaining charges is equal to or less than the prescribed amount, the program advances from the step S11 to a step S12. Otherwise, the program exits from the step S11 and then the current execution cycle of the program segment ends.

The step S12 decides whether or not a still-picture file is being written into the memory card 16. It should be noted that communications with the still-picture record/reproduction control microcomputer 14 cause the central processing microcomputer 5 to know whether or not a still-picture file is being written into the memory card 16. When it is decided that a still-picture file is being written into the memory card 16, the program advances from the step S12 to a step S13. Otherwise, the program jumps from the step S12 to a step S14.

The step S13 sends the still-picture record/reproduction control microcomputer 14 a command to suspend an access to the still-picture file which is being transferred toward the memory card 16. After the step S13, the program advances to the step S14.

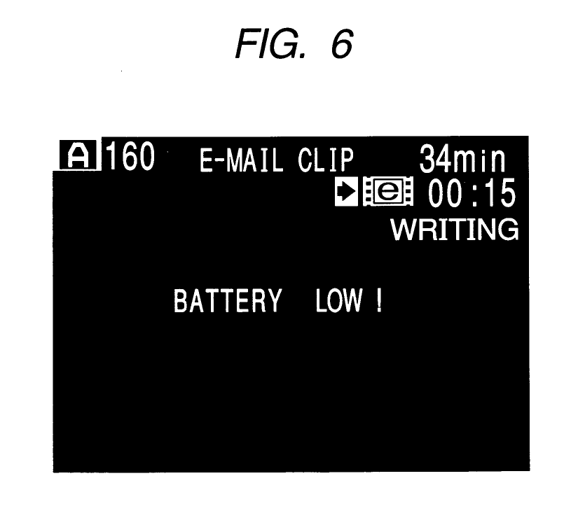

The step S14 inhibits the digital camera from responding to the states of the first-stage switch and the second-stage switch in the recording switch arrangement. The step S14 controls the liquid crystal display in the AV output portion 18 via the image processing DSP 4 and the D/A converter 17 on an OSD basis to indicate a picture having red letters “BATTERY LOW” which periodically go on and off. An example of this indicated picture is shown in FIG. 6. The flashing red letters “BATTERY LOW” constitute a warning to the user, and notify the user that only a small amount of charges remains in the battery 21. After the step S14, the current execution cycle of the program segment ends.

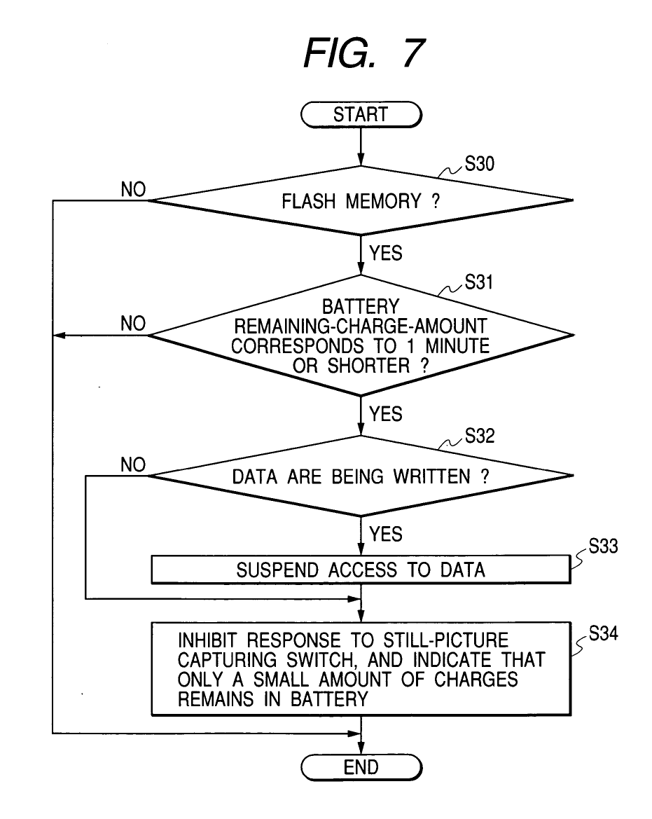

If the battery 21 became dead during the writing of data into a memory card 16 of the flash type, a defective still-picture file would be recorded therein. FIG. 7 is a flowchart of a third segment of the control program for the central processing microcomputer 5 which implements the prevention of such a problem. The program segment in FIG. 7 is repetitively executed during the still-picture recording mode of operation of the digital camera.

With reference to FIG. 7, a first step S30 of the program segment retrieves the type flag from the suitable memory within the central processing microcomputer 5. The step S30 refers to the type flag and thereby decides whether or not the memory card 16 currently connected with the camera body is of the flash type. When it is decided that the memory card 16 is of the flash type, the program advances from the step S30 to a step S31. Otherwise, the program exits from the step S30 and then the current execution cycle of the program segment ends.

The step S31 accesses the battery remaining-charge-amount detector 20 to get information indicating the present amount of charges remaining in the battery 21. The step S31 compares the present amount of remaining charges with a prescribed amount (a threshold value) which enables the digital camera to continuously operate for one minute. When the present amount of remaining charges is equal to or less than the prescribed amount, the program advances from the step S31 to a step S32. Otherwise, the program exits from the step S31 and then the current execution cycle of the program segment ends.

The step S32 decides whether or not a still-picture file is being written into the memory card 16. When it is decided that a still-picture file is being written into the memory card 16, the program advances from the step S32 to a step S33. Otherwise, the program jumps from the step S32 to a step S34.

The step S33 sends the still-picture record/reproduction control microcomputer 14 a command to suspend an access to the still-picture file which is being transferred toward the memory card 16. After the step S33, the program advances to the step S34.

The step S34 inhibits the digital camera from responding to the states of the first-stage switch and the second-stage switches in the recording switch arrangement. The step S34 controls the liquid crystal display in the AV output portion 18 via the image processing DSP 4 and the D/A converter 17 on an OSD basis to indicate a picture having red letters “BATTERY LOW” which periodically go on and off. The flashing red letters “BATTERY LOW” constitute a warning to the user. After the step S34, the current execution cycle of the program segment ends.

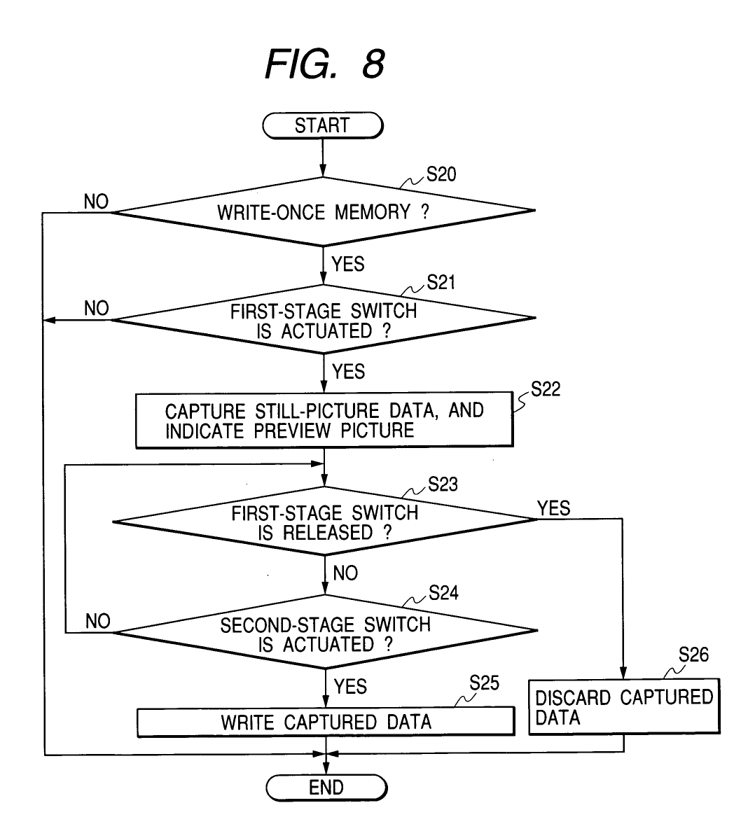

FIG. 8 is a flowchart of a fourth segment of the control program for the central processing microcomputer 5. The program segment in FIG. 8 is repetitively executed during the still-picture recording mode of operation of the digital camera.

With reference to FIG. 8, a first step S20 of the program segment retrieves the type flag from the suitable memory within the central processing microcomputer 5. The step S20 refers to the type flag and thereby decides whether or not the memory card 16 currently connected with the camera body is of the write-once type. When it is decided that the memory card 16 is of the write-once type, the program advances from the step S20 to a step S21. Otherwise, the program exits from the step S20 and then the current execution cycle of the program segment ends.

The step S21 accesses the operation unit 6 and gets information about the present state of the first-stage switch in the recording switch arrangement. The step S21 decides whether or not the first-stage switch is in its ON state. When it is decided that the first-stage switch is in its ON state, the program advances from the step S21 to a step S22. Otherwise, the program exits from the step S21 and then the current execution cycle of the program segment ends.

The step S22 controls the still-picture DSP 12 via the still-picture record/reproduction control microcomputer 14 to capture the current luminance signal and the current chrominance difference signals as a video signal representing a 1-frame still picture, and to store the captured video signal into the SDRAM 13. Then, the step S22 controls the image processing DSP 4, the still-picture DSP 12, the SDRAM 13, the still-picture record/reproduction control microcomputer 14, the D/A converter 17, and the AV output portion 18 to transfer the video signal from the SDRAM 13 to the AV output portion 18, and to indicate the video signal on the liquid crystal display within the AV output portion 18. Thus, the still picture represented by the video signal is indicated on the liquid crystal display as a preview picture. After the step S22, the program advances to a step S23.

The step S23 accesses the operation unit 6 and gets information about the present state of the first-stage switch in the recording switch arrangement. The step S23 decides whether or not the first-stage switch is out of its ON state. When it is decided that the first-stage switch is out of its ON state, the program advances from the step S23 to a step S26. Otherwise, the program advances from the step S23 to a step S24.

The step S24 accesses the operation unit 6 and gets information about the present state of the second-stage switch in the recording switch arrangement. The step S24 decides whether or not the second-stage switch is in its ON state. When it is decided that the second-stage switch is in its ON state, the program advances from the step S24 to a step S25. Otherwise, the program returns from the step S24 to the step S23.

The step S25 controls the still-picture DSP 12 via the still-picture record/reproduction control microcomputer 14 to access the video signal in the SDRAM 13, to subject the video signal to compression and other processing to get R, G, and B signals representative of the still-picture, and to feed the R, G, and B signals to the still-picture record/reproduction control microcomputer 14. The step S25 controls the still-picture record/reproduction control microcomputer 14 to generate a file of the still picture from the R, G, and B signals, and to transfer the still-picture file to the interface 15. The step S25 controls the interface 15 via the still-picture record/reproduction control microcomputer 14 to record the still-picture file on the memory card 16. After the step S25, the current execution cycle of the program segment ends.

The step S26 controls the still-picture DSP 12 via the still-picture record/reproduction control microcomputer 14 to erase the captured video signal from the SDRAM 13. After the step S26, the current execution cycle of the program segment ends.

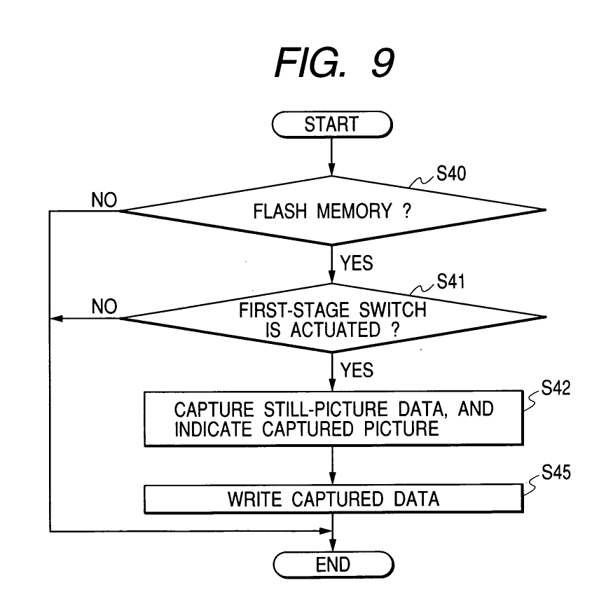

FIG. 9 is a flowchart of a fifth segment of the control program for the central processing microcomputer 5. The program segment in FIG. 9 is repetitively executed during the still-picture recording mode of operation of the digital camera.

With reference to FIG. 9, a first step S40 of the program segment retrieves the type flag from the suitable memory within the central processing microcomputer 5. The step S40 refers to the type flag and thereby decides whether or not the memory card 16 currently connected with the camera body is of the flash type. When it is decided that the memory card 16 is of the flash type, the program advances from the step S40 to a step S41. Otherwise, the program exits from the step S40 and then the current execution cycle of the program segment ends.

The step S41 accesses the operation unit 6 and gets information about the present state of the first-stage switch in the recording switch arrangement. The step S41 decides whether or not the first-stage switch is in its ON state. When it is decided that the first-stage switch is in its ON state, the program advances from the step S41 to a step S42. Otherwise, the program exits from the step S41 and then the current execution cycle of the program segment ends.

The step S42 controls the still-picture DSP 12 via the still-picture record/reproduction control microcomputer 14 to capture the current luminance signal and the current chrominance difference signals as a video signal representing a 1-frame still picture, and to store the captured video signal into the SDRAM 13. Preferably, the step S42 controls the image processing DSP 4, the still-picture DSP 12, the SDRAM 13, the still-picture record/reproduction control microcomputer 14, the D/A converter 17, and the AV output portion 18 to transfer the video signal from the SDRAM 13 to the AV output portion 18, and to indicate the video signal on the liquid crystal display within the AV output portion 18. Thus, in this case, the still picture represented by the video signal is indicated on the liquid crystal display as a monitor-purpose picture. After the step S42, the program advances to a step S45.

The step S45 controls the still-picture DSP 12 via the still-picture record/reproduction control microcomputer 14 to access the video signal in the SDRAM 13, to subject the video signal to compression and other processing to get R, G, and B signals representative of the still-picture, and to feed the R, G, and B signals to the still-picture record/reproduction control microcomputer 14. The step S45 controls the still-picture record/reproduction control microcomputer 14 to generate a file of the still picture from the R, G, and B signals, and to transfer the still-picture file to the interface 15. The step S45 controls the interface 15 via the still-picture record/reproduction control microcomputer 14 to record the still-picture file on the memory card 16. After the step S45, the current execution cycle of the program segment ends.

As previously explained, the digital camera is equipped with systems for automatically controlling a focus and an exposure with respect to pictures taken by the CCD imager 2. The automatic focus and exposure control systems continue to be active during operation of the digital camera. The central processing microcomputer 5 is designed to enable the automatic focus and exposure control systems to operate independent of the states of the first-stage switch and the second-stage switch in the recording switch arrangement.

It is hard or tough to erase data from the memory card 16 of the write-once type. Also, it is hard or tough to rewrite data in the memory card 16 of the write-once type. In prescribed conditions of operation of the digital camera, the liquid crystal display in the AV output portion 18 is controlled to indicate an on-screen menu listing functions. Some of the listed functions are disabled with respect to a recording medium 16 of the write-once type although they are enabled with respect to a recording medium 16 of the flash type. Preferably, the digital camera is designed to implement the following steps of operation. The type flag is retrieved. The type flag is referred to, and thereby a decision is made as to whether or not the memory card 16 currently connected with the camera body is of the write-once type. When it is decided that the memory card 16 is of the write-once type, the color of on-screen menu portions indicative of the disabled functions is changed from normal one to notify the user of the disabled functions. The disabled functions are as follows.

\mathring{1} FORMAT: initialization of a memory card 16 or deletion of all data from a memory card 16;

\mathring{2} PROTECT: inhibition of deletion of picture data;

\mathring{3} DELETE: deletion of picture data; and

\mathring{4} DPOF setting: setting of the number of prints of a digital print order format.

In the case where the above-indicated functions \mathring{1}-\mathring{4} are assigned to respective switches within the operation unit 6, the reception of signals from these switches is inhibited.

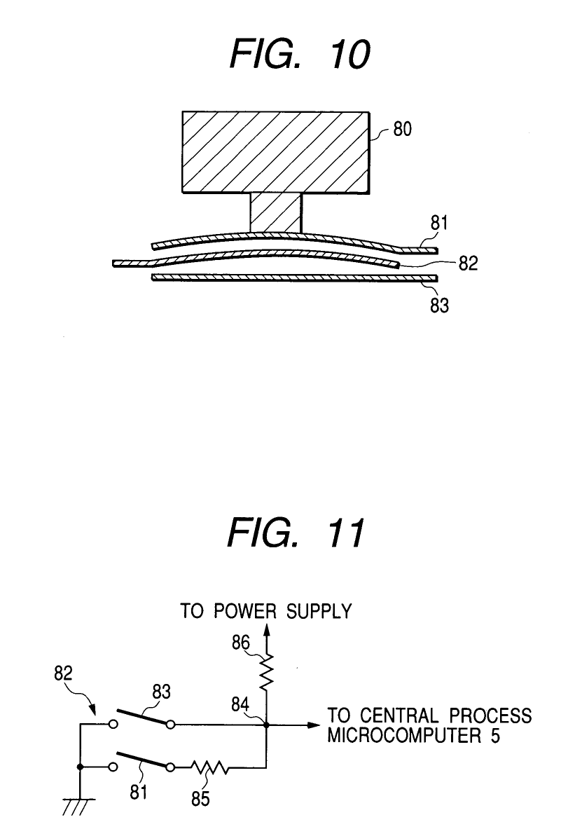

FIG. 10 shows an example of the recording switch arrangement in the operation unit 6. The recording switch arrangement in FIG. 10 includes a button 80, a first electrode 81, a second electrode 82, and a third electrode 83. The button 80 engages the first electrode 81. Thus, the first electrode 81 is displaced in accordance with movement of the button 80. Normally, a return spring (not shown) or the first electrode 81 holds the button 80 in its uppermost position, that is, its undepressed position. The second electrode 82 is located between the first electrode 81 and the third electrode 83. As will be made clear later, the first electrode 81 and the second electrode 82 compose a first-stage switch. The second electrode 82 and the third electrode 83 compose a second-stage switch.

As shown in FIG. 11, the first electrode 81 leads to a common junction 84 via a resistor 85. The second electrode 82 is grounded. The third electrode 83 is directly connected with the common junction 84. The common junction 84 is connected via a resistor 86 to the positive terminal of a DC power supply (not shown). The negative terminal of the DC power supply is grounded. The common junction 84 leads to an A/D converter in an input port of the central processing microcomputer 5.

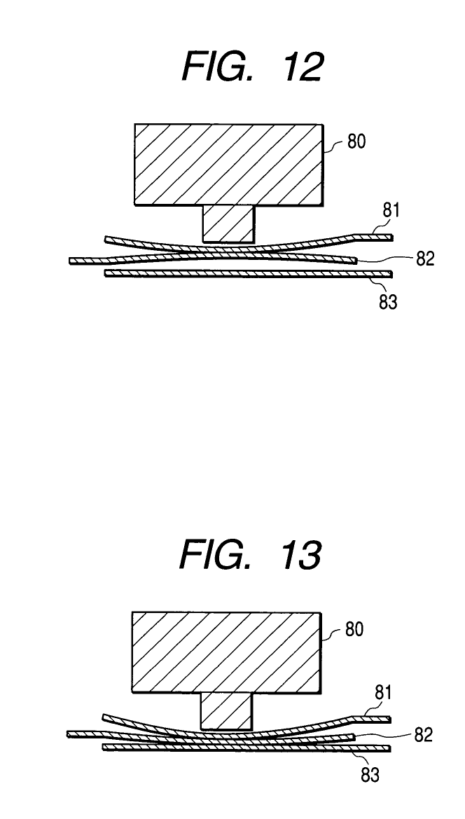

When the button 80 is in its undepressed position (its uppermost position) as shown in FIG. 10, the first, second, and third electrodes 81, 82, and 83 are separate from each other. In this case, both the first-stage switch and the second-stage switch are in their OFF states. When the button 80 is moved from its undepressed position to its partially depressed position as shown in FIG. 12, the first electrode 81 is displaced into contact with the second electrode 82. Thus, the first-stage switch assumes its ON state. In this case, the second electrode 82 remains separate from the third electrode 83 so that the second-stage switch continues to be in its OFF state. When the button 80 is moved from its partially depressed position to its fully depressed position (its lowermost position) as shown in FIG. 13, the second electrode 82 is displaced into contact with the third electrode 83. Thus, the second-stage switch assumes its ON state. In this case, the first electrode 81 remains in contact with the second electrode 82 so that the first-stage switch continues to be in its ON state.

When the button 80 is in its undepressed position (see FIG. 10), both the first-stage switch and the second-stage switch are in their OFF states so that a highest voltage appears at the common junction 84 in FIG. 11. The highest voltage is transmitted from the common junction 84 to the central processing microcomputer 5 as an indication that both the first-stage switch and the second-stage switch are in their OFF states. When the button 80 is in its partially depressed position (see FIG. 12), the first-stage switch is in its ON state and the second-stage switch is in its OFF state so that an intermediate voltage appears at the common junction 84. The intermediate voltage is transmitted from the common junction 84 to the central processing microcomputer 5 as an indication that the first-stage switch is in its ON state and the second-stage switch is in its OFF state. When the button 80 is in its fully depressed position (see FIG. 13), both the first-stage switch and the second-stage switch are in their ON states so that a lowest voltage appears at the common junction 84. The lowest voltage is transmitted from the common junction 84 to the central processing microcomputer 5 as an indication that both the first-stage switch and the second-stage switch are in their ON states.

### Advantage Provided by the Invention

The recording switch arrangement in the operation unit 6 has the first-stage switch, the second-stage switch, and the common button (the still-picture capturing button) mechanically connected with the first-stage switch and the second-stage switch. A decision is made as to whether or not the memory card 16 currently connected with the camera body is of the write-once type. When it is decided that the memory card 16 is of the write-once type, the digital camera operates in response to the states of the first-stage switch and the second-stage switch of the recording switch arrangement as follows. When the still-picture capturing button is partially depressed so that only the first-stage switch changes to its ON state, the digital camera captures a current picture and indicates the captured picture as a preview picture. When the still-picture capturing button is further depressed so that the second-stage switch also changes to its ON state, the digital camera records data representative of the captured picture on the memory card 16 as data representative of a still picture. On the other hand, when the still-picture capturing button is released without being further depressed so that the first-stage switch returns to its OFF state and the second-stage switch continues to be in its OFF state, the digital camera prevents data representative of the captured picture from being recorded on the memory card 16. These steps of operation of the digital camera are effective in avoiding still-picture data from being erroneously written into the memory card 16 of the write-once type.

What is claimed is:

1. A digital camera with which a recording medium is connectable, the digital camera comprising:
first means for deciding whether a connected recording medium is of a first type into and from which data can be written and erased a plurality of times or a second type into which data can be written only once;
a recording switch arrangement having a first-stage switch and a second-stage switch;
second means for writing still-picture data into the connected recording medium when the first-stage switch is actuated in cases where the first means decides that the connected recording medium is of the first type;
third means for capturing data representative of a still picture and indicating the still picture represented by the captured data as a preview picture when the first-stage switch is actuated in cases where the first means decides that the connected recording medium is of the second type; and
fourth means for writing the captured data into the connected recording medium when the second-stage switch is actuated in cases where the first-stage switch remains actuated and the first means decides that the connected recording medium is of the second type.

2. A digital camera as recited in claim 1, further comprising:
fifth means for detecting an amount of charges remaining in a battery;
sixth means for deciding whether or not the amount detected by the fifth means is greater than a threshold value;
seventh means for inhibiting the second means and the third means from responding to actuation of the first-stage switch and for giving a warning to a user in cases where the sixth means decides that the detected amount is not greater than the threshold value;
eighth means for setting the threshold value to a first value when the first means decides that the connected recording medium is of the first type; and
ninth means for setting the threshold value to a second value greater than the first value when the first means decides that the connected recording medium is of the second type.

3. A digital camera as recited in claim 1, further comprising an imager for sequentially taking pictures, and fifth means for automatically controlling a focus and an exposure with respect to the pictures taken by the imager independent of an operating condition of the recording switch arrangement.

4. A digital camera as recited in claim 1, further comprising fifth means for indicating, to a user, functions disabled with respect to a recording medium of the second type and enabled with respect to a recording medium of the first type.

5. A digital camera with which a recording medium is connectable, the digital camera comprising:
first means for deciding whether a connected recording medium is of a first type into and from which data can be written and erased a plurality of times or a second type into which data can be written only once;
a button being movable among an undepressed position, a first depressed position, and a second depressed position, and passing through the first depressed position as moving from the undepressed position to the second depressed position;
second means for writing first still-picture data into the connected recording medium when the button is moved from the undepressed position to the first depressed position in cases where the first means decides that the connected recording medium is of the first type;
third means for indicating a still picture represented by second still-picture data as a preview picture when the button is moved from the undepressed position to the first depressed position in cases where the first means decides that the connected recording medium is of the second type; and
fourth means for writing the second still-picture data into the connected recording medium when the button is further moved from the first depressed position to the second depressed position in cases where the first means decides that the connected recording medium is of the second type.

6. A digital camera as recited in claim 5, further comprising:
fifth means for detecting an amount of charges remaining in a battery;
sixth means for deciding whether or not the amount detected by the fifth means is greater than a threshold value;
seventh means for inhibiting the second means and the fourth means from writing the first still-picture data and the second still-picture data into the connected recording medium and for giving a warning in cases where the sixth means decides that the detected amount is not greater than the threshold value;
eighth means for setting the threshold value to a first value when the first means decides that the connected recording medium is of the first type; and
ninth means for setting the threshold value to a second value greater than the first value when the first means decides that the connected recording medium is of the second type.

7. A digital camera as recited in claim 5, further comprising an imager for sequentially taking pictures, and fifth means for automatically controlling a focus and an exposure with respect to the pictures taken by the imager independent of the position of the button.

8. A digital camera as recited in claim 5, further comprising fifth means for indicating functions disabled with respect to a recording medium of the second type and enabled with respect to a recording medium of the first type.

9. A digital camera with which a recording medium is connectable, the digital camera comprising:
a first device deciding whether a connected recording medium is of a first type into and from which data can be written and erased a plurality of times or a second type into which data can be written only once;
a recording switch arrangement having a first-stage switch and a second-stage switch;
a data writer writing still-picture data into the connected recording medium when the first-stage switch is actuated in cases where the first device decides that the connected recording medium is of the first type; and
a second device capturing data representative of a still picture and indicating the still picture represented by the captured data as a preview picture when the first-stage switch is actuated in cases where the first device decides that the connected recording medium is of the second type;
the data writer writing the captured data into the connected recording medium when the second-stage switch is actuated in cases where the first-stage switch remains actuated and the first device decides that the connected recording medium is of the second type.

10. A digital camera with which a recording medium is connectable, the digital camera comprising:
a first device deciding whether a connected recording medium is of a first type into and from which data can be written and erased a plurality of times or a second type into which data can be written only once;
a button being movable among an undepressed position, a first depressed position, and a second depressed position, and passing through the first depressed position as moving from the undepressed position to the second depressed position;
a data writer writing first still-picture data into the connected recording medium when the button is moved from the undepressed position to the first depressed position in cases where the first device decides that the connected recording medium is of the first type; and
a second device indicating a still picture represented by second still-picture data as a preview picture when the button is moved from the undepressed position to the first depressed position in cases where the first device decides that the connected recording medium is of the second type;
the data writer writing the second still-picture data into the connected recording medium when the button is further moved from the first depressed position to the second depressed position in cases where the first device decides that the connected recording medium is of the second type.
